(19) United States
(12) Patent Application Publication
(10) Pub. No.: US 2007/0001796 A1
(43) Pub. Date: Jan. 4, 2007

(54) Printed circuit board with integrated inductor

(76) Inventors: Eberhardt Waffenschmidt, Aachen (DE); Bernd Ackermann, Aachen (DE); Henricus Petronella Maria Derckx, Weert (NL); Wilheimus Johannes Robertus Lier, Roermond (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/569,216

(22) PCT Filed: Aug. 24, 2004
(86) PCT No.: PCT/IB04/51540

§ 371 Date: Feb. 23, 2006

(30) Foreign Application Priority Data
Aug. 26, 2003 (EP) 03102648.7
Sep. 4, 2003 (EP) 03102694.1

(51) Int. Cl. H01F 27/28

(52) U.S. Cl. 336/223

(57) ABSTRACT

Printed Circuit Board with Integrated Inductor. In today's electronic devices components such as inductors are required having a small building height. According to the present invention, a core of an inductor may be realized by ferrite plates glued onto a substrate. A winding of the inductor is provided in the substrate. Advantageously, this may allow to provide an inductor having a simple arrangement and a reduced building height.

The present invention relates to printed circuit boards and inductors. In particular, the present invention relates to a printed circuit board with an inductor, to an inductor and to a method of manufacturing an inductor.

In a great number of today's electrical devices, such as mobile communication devices, voltages are required that differ from a DC-voltage provided for example from a battery. To convert the voltage efficiently, inductors are needed. Today, thin surface mounted (SMT) inductors are used. They are offered by various manufacturers. Such a typical SMT inductor comprises a thin drum made of sintered ferrite. The diameter of the core may be approximately 4.3 mm and the height of the core may be approximately 1 mm. A winding is formed by thin copper wire wound between upper parts and a lower part of the core. Such SMT inductors are usually provided with plastic fixtures with contacts to mount the device to a printed circuit board (PCB).

Due to the fact that a plastic fixture usually needs to be provided and that the core needs to be specially shaped with a gap of a large aspect ratio to accommodate the wire winding, such SMT inductors are complicated to manufacture and rather expensive. In addition to that, due to the additional plastic fixture, a building height of the SMT inductor in the range of 1 mm which is too large for an application in space sensitive applications such as, for example, mobile phones.

DE 31 35 962 A1 discloses a micro coil arrangement where a flat conductor is provided on an insulation substrate which is sandwiched between magnetic materials.

It is an object of the present invention to provide a printed circuit board with an inductor having a simple arrangement.

According to an exemplary embodiment of the present invention as set forth in claim 1, a printed circuit board with an inductor is provided comprising a substrate, an inductor core and a first winding. The first winding is provided in the substrate. The inductor core comprises a first softmagnetic layer and a second softmagnetic layer which are provided on first and second sides of the substrate.

Due to the provision of the winding in the substrate, a printed circuit board with an inductor may be provided advantageously having a very simple, solid and thus reliable arrangement. Furthermore, due to the fact that simple soft magnetic layers form the inductor core, instead of a specially shaped core, the printed circuit board according to this exemplary embodiment of the present invention may be manufactured at low cost, with a simple manufacturing process. The inductor core does not need to be pre-manufactured.

Advantageously, according to this exemplary embodiment of the present invention, a high flexibility is provided with respect to the inductor value and/or the transformer ratio if the inductor is used in a transformer.

Furthermore, advantageously, due to this exemplary embodiment of the present invention, no holes or recesses need to be formed or provided in the substrate for accommodating the inductor core. Advantageously, due to the fact that no holes are necessary, the inductor winding may using that space which may allow to provide for an inductor having a very small size.

According to another exemplary embodiment of the present invention as set forth in claim 2, the substrate comprises a conductive layer. Furthermore, a wiring is provided. The wiring may, for example, be provided for contacting the winding. The winding and the wiring are provided in the same conductive layer of the substrate.

In other words, the winding of the inductor and the wiring, for example, for contacting the winding of the inductor, are provided in the same conductive layer of the substrate, which, for example, may be a copper or aluminium layer.

Advantageously, according to this exemplary embodiment of the present invention, the winding is basically for free because the winding is made of the conductive layer which may, anyway, be provided in the substrate of the printed circuit board.

In a further modification of this embodiment, a shielding against magnetic fields is provided. For shielding of the first side of the substrate, it is particularly suitable to provide an electrically conductive layer on top of the first softmagnetic layer. Most preferably, use is made of aluminum. This metal is advantageous over copper, as it can be readily deposited by sputtering or other known deposition technique on the softmagnetic layer. Nevertheless, and contrarily to mumetal, the shielding of an aluminum layer is excellent.

Alternatively, but preferably additionally, the shielding can be implemented in the conductive layer of the substrate, in which the winding is defined as well. A shorted turn that is circumferential to the winding of the inductor, is found to provide a good shielding to the side faces of the substrate. The position of this shielding turn is suitably outside the surface area covered by the softmagnetic layer, and preferably directly adjacent to it. This shielding results in a remarkable limitation of the magnetic field. Without the shielding turn the magnetic field was found to extend from the edge of the substrate parallel to and perpendicular to the substrate. This extension was found to be 6 mm from the edge in both directions, for a substrate of a radius of 12 mm. In the device according to the invention, the extension was reduced to 2 mm and 4 mm for a substrate of the same size.

According to another exemplary embodiment, the wiring provided in the same conductive layer of the substrate as the winding is for interconnecting the inductor to the components which may be provided on the printed circuit board.

Advantageously, this may allow to provide the winding and the interconnections to other components in the same manufacturing step, for example, by a photolithographic process and a successive etching.

According to another exemplary embodiment of the present invention as set forth in claim 4, the first and second magnetic layers are plates of sintered ferrite.

Advantageously, this may provide for a printed circuit board with an inductor having a very simple arrangement being cheap to manufacture, since such simple ferrite plates, in contrast to shaped cores, do not need to be polished to obtain reproducible magnetic properties. Furthermore, an inductor core made of ferrite plates may be easily manufactured from bulk material, for example, by breaking the ferrite plate from large tiles.

According to another exemplary embodiment of the present invention as set forth in claim 5, the substrate is a flex foil and the plates of sintered ferrite are glued to the flex foil which allows for providing a flexible planar inductor which is integrated into the printed circuit board.

According to another exemplary embodiment of the present invention as set forth in claim 6, the substrate has no holes for the inductor core which allows for a simple manufacturing. Since no holes are necessary in the substrate, the inductor winding may use the space usually occupied by such holes for accommodating the inductor core. Advantageously, this allows to provide for an inductor having a very small size.

In an alternative embodiment, however, the substrate includes a hole, which is filled at least partially with softmagnetic material. This hole is a through-hole, and can be of a size that is considerably reduced, in comparison to the holes used for the positioning of a complete inductor core. The magnetic interconnection allows enhancement of the inductivity.

Advantageously, the through-hole is filled with a plurality of layers: an electrically conducting layer at the side faces of the through-hole, an insulating layer and a softmagnetic material. The conducting layer is used herein to contact the inner end of the planar winding. The insulating layer has the purpose of adequate isolation, but may be dispensed with, particularly if the softmagnetic material includes such isolation.

Most suitably, the softmagnetic layer preferably contains a matrix of polymer material in which softmagnetic powder is embedded. Herewith the softmagnetic material includes the electrical insulation. Suitable materials for the softmagnetic powder include among others ferrite, μ-metal, amorphous and nanocrystalline iron. The polymer matrix can be applied as a paste, and has an adhesive function in addition to the magnetic function and an electrically insulating function; suitably, it is applied on both sides of the substrate. The first and second softmagnetic layers can then be attached to the substrate with this polymer matrix as an adhesive. The paste will be cured afterwards, for instance with heat or UV-radiation or as a consequence of the exposure to oxygen in the air.

In a further modification of said advantageous filling arrangement, the conducting layer is present at a portion of the side face of the through-hole only. In other words, a portion of the side face that extends from the first side to the second side, is free of electrically conducting material. This has the substantial advantage that the said conducting layer does not function as a short. The short may contribute to the losses of the inductive component considerably, particularly in case of small spiral windings. This measure to limit the extension of the conducting layer, is particularly desired for the present embodiment with the softmagnetic material in the through-hole, in view of the increases magnetic fluxes.

This reduced extension of the conducting layer, in comparison to conventional through-holes in printed circuit boards, may in a first suitable form be designed as an additional turn of the winding. In a second form, the through-hole may be used for the connection of more than one winding. Such plurality of windings is present with certain inductive components, such as planar transformers. In a third form, a plurality of through-holes filled with softmagnetic material is present. This allows the provision of structures in a substrate that correspond to the structures of discrete cores, such as the U-shape, the E-shape and the like.

According to another exemplary embodiment of the present invention as set forth in claim 7, a multilayer arrangement is provided where a plurality of windings are provided in a plurality of layers in the substrate.

Advantageously, this may allow for complex winding layouts, for example, for transformers or for windings with intermediate connections. Advantageously, due to this, circuit topologies may be realized where only one component, such as one inductor with a complex winding is used, instead of two or more simple inductors. By this, a component count and a circuit size of circuits provided in the printed circuit board may be reduced.

According to another exemplary embodiment of the present invention as set forth in claim 8, the distance between the softmagnetic layers is set, such that it can be considered as an air gap in a magnetic path of a magnetic flux occurring between the first and second softmagnetic layers during operation of the inductor.

According to another exemplary embodiment of the present invention as set forth in claim 9, an inductor is provided where softmagnetic layers provided on sides of a substrate form the core of the inductor and where the winding of the inductor is provided in the substrate.

Advantageously, an inductor may be provided having a very simple and robust arrangement. Furthermore, due to the inductor core which does not need a hole in the substrate, a very small inductor may be provided having a reduced thickness.

Claim 10 provides for an exemplary embodiment of the inductor according to the present invention.

According to another exemplary of the present invention as set forth in claim 11, a method of manufacturing an inductor is provided where softmagnetic layers are provided on the sides of the substrate into which a winding has been embedded.

Advantageously, the method according to this exemplary embodiment of the present invention is simple, fast and reliable, due to the fact that no holes need to be provided in the substrate for forming the core of the inductor.

Claims 12 to 14 provide further exemplary embodiments of the method according to the present invention where, according to one of the exemplary embodiments, plates of sintered ferrite are used as softmagnetic layers which are glued on top and bottom of the substrate. This may allow for a simple and cheap manufacturing.

It may be seen as a gist of an exemplary embodiment of the present invention that the winding of the inductor is provided in the substrate. Due to this, a conductive layer, such as a copper layer in the substrate may be used for the winding which is, anyway, used, for example, for the connections of the inductor to other components on the printed circuit board. Furthermore, simple ferrite plates may be used to form the core of the inductor which allows for a cheap manufacture of an inductor or a printed circuit board with an inductor. By this, an inductor may be provided having a very small building height which is integrated into the substrate or the printed circuit board.

These and other aspects of the present invention will become apparent from and elucidated with reference to the embodiments described hereinafter.

Exemplary embodiments of the present invention will be described in the following with reference to the following drawings:

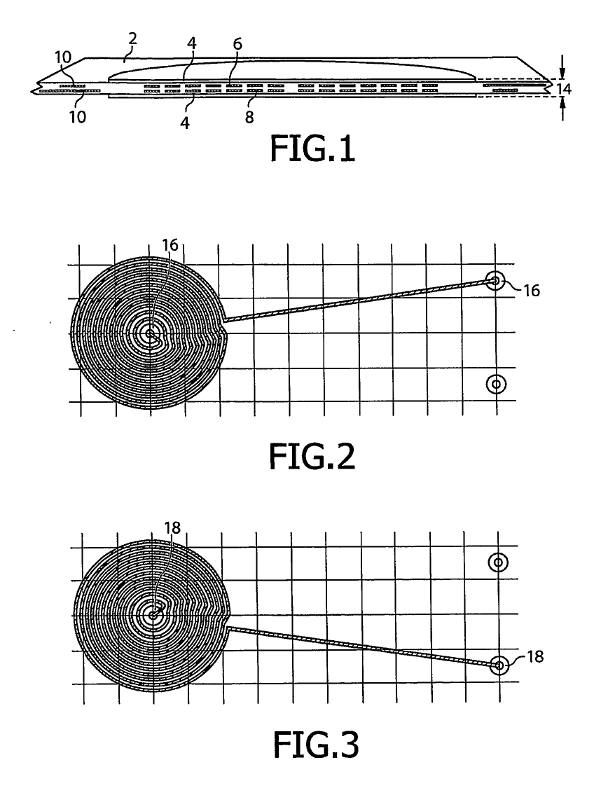

FIG. 1 shows a sectional view of an inductor according to an exemplary embodiment of the present invention.

FIG. 2 shows an exemplary embodiment of a winding layout as may be used in the inductor of FIG. 1.

FIG. 3 shows another exemplary embodiment of a winding layout as may be used in the inductor of FIG. 1.

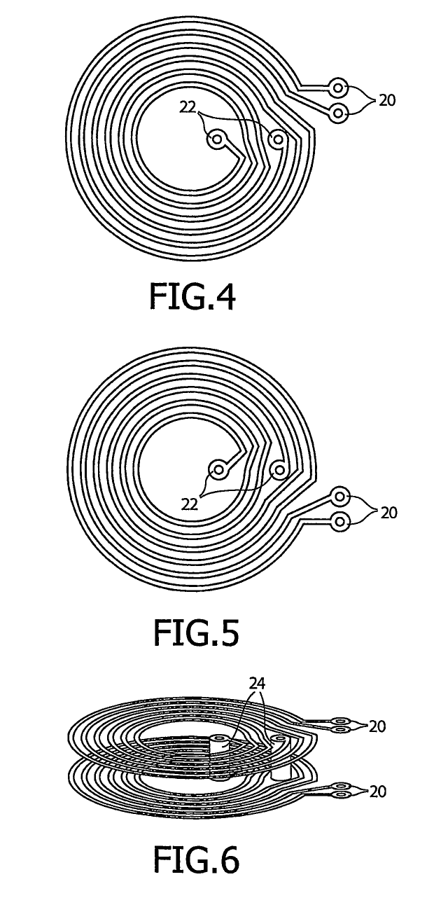

FIG. 4 shows yet another exemplary embodiment of a winding layout as may be used in the inductor of FIG. 1.

FIG. 5 shows yet another exemplary embodiment of a winding layout as may be used in the inductor of FIG. 1.

FIG. 6 shows a perspective view of a combination of the winding layouts of FIGS. 4 and 5 with interconnections to form a multilayer component.

FIG. 1 shows a cross-sectional view of a Printed Circuit Board (PCB) with an inductor according to the present invention. As may be taken from FIG. 1, the PCB comprises a substrate 2 with a first side and a second side. Within the substrate 2 there is provided a winding 6 and 8. The winding 6 and 8 is embedded in the substrate 2 and thus forms an integral part of the substrate 2. A core of the inductor is formed by softmagnetic layers 4 arranged on the first and second sides of the substrate 2, such that the winding 6 and 8 is at least partially covered by the softmagnetic layers 4.

In FIG. 1, the inductor has a circular shape. Thus, the softmagnetic layers 4 arranged on the substrate 2 have a circular shape. A thickness of the softmagnetic layers 4 may be very thin, such as in the range of 25 μm to 100 μm. However, it may also be possible to use softmagnetic layers 4 having a thickness in the range of 50 μm to 150 μm or 50 μm to 75 μm. Also, ferrite plates may be used having a thickness in the range of 100 μm to 500 μm. Preferably, the core is made from ferrite plates.

According to an exemplary embodiment of the present invention, the first magnetic layers 4 are made of ferrite. For example, the softmagnetic layers 4 may be realized by using ferrite plates which are glued on the upper and lower sides of the substrate. Preferably, the plates are made of sintered ferrite.

According to an aspect of this exemplary embodiment of the present invention, the dimensions and the contact arrangement of the inductor is such that it corresponds to a conventional SMT component, such that it may be used to replace conventional SMT components in already finished designs. However, it should be noted that the building height 14 of the inductor is much less than that of an SMT component. For example, a total building height of less than 1 mm may be achieved. Even lower building heights 14 with less than 200 μm are feasible.

As may be taken from FIG. 1, windings 6 and 8 are provided in a flush arrangement in the substrate 2. According to an aspect of the present invention, the windings are made from the same conducting layers, such as copper or aluminium layers in the substrate which are used to make interconnects between other components which may be arranged on the printed circuit board or connections to the outside. By this, as already mentioned above, a very small building height 14 may be provided. In other words, the windings 6 and 8 are formed into the same conductive layers as wirings 10 which are provided for forming interconnections between the inductor and other components or circuit structures of other circuits provided in the substrate. Due to this, the winding is “for free”, since it is manufactured from the conductive layer(s) which are provided anyway in the substrate for the wirings 10 or other wirings.

The substrate 2 may, for example, have rigid insulation layers, for example, made from FR4 material between the conductive layers. However, the substrate 2 may also be a flexible substrate. An example for a flexible substrate is a flex foil which refers to a printed circuit board where the insulation layers, for example made from polymers, which are provided between the conductive layers, such as the copper layers, are flexible.

Also, according to an aspect of this exemplary embodiment of the present invention, the substrate itself may be the printed circuit board.

As mentioned above, the softmagnetic layers 4 are preferably realized by ferrite plates. Advantageously, such ferrite plates as inductor cores need not be polished to obtain reproducible magnetic properties. Also, they can easily be made from a bulk material, for example, broken from large tiles, which ensures a simple manufacture. Also, it has to be noted that quadratic or rectangular shapes or other suitable shapes of the inductor windings and/or the core are possible. The winding and the core don't necessarily need to have the same shape, e.g. a circular winding (for low resistance) may be combined with a square core (easy to manufacture).

Furthermore, as may be taken from FIG. 1, no holes are provided in the substrate 2 for accommodating the core of the inductor. Advantageously, this may allow that the winding may use the space usually occupied by these holes for the core. By this, a very small inductor may be provided.

Due to the use of ferrite plates as core of the inductor, the magnetic path induced in the core during operation of the inductor is not closed completely. However, according to an aspect of an exemplary embodiment of the present invention, the ferrite plates, i.e., the softmagnetic layers are close together, such that a distance between them can be considered as an air gap in the magnetic path. For example, the distance between the softmagnetic layers, i.e., the ferrite plates, my be in the range of 50 μm to 500 μm. A typical thickness of a two-layer flex foil may be about 200 μm.

FIGS. 2 and 3 show top views of winding layouts according to an exemplary embodiment of the present invention as they may be used for the windings 6 and 8 (two copper layers 6 and 8) of the inductor depicted in FIG. 1. As may be taken from FIGS. 2 and 3, the windings may have the shape of a spiral. A comparison of the winding directions of FIGS. 2 and 3 shows that according to an aspect of this exemplary embodiment of the present invention, a winding direction of both layers is opposite to each other: in FIG. 2 the winding direction is clockwise, while in FIG. 3 the winding direction is counterclockwise.

The winding layout depicted in FIGS. 2 and 3 may be used to form a 10 μH inductor realized with two copper layers in a standard technology with 80 μm track width and 80 μm track distance. Such an inductor may be designed for the use in a mobile phone display circuit. A diameter of the windings may fit between the paths of a conventional 10 μH SMT inductor. The core plates may have a diameter of 6.9 mm, which is the outer distance of the paths of a conventional SMT inductor. Therefore, the integrated inductor as depicted in FIG. 1 may immediately replace the SMT inductor on the same area. Since the thickness of the core plates may be as low as 0.2 mm, a total of thickness, i.e., the total building height 14 may be reduced to 600 μm compared to more than 1 mm for the conventional SMT inductor.

As depicted in FIG. 1, the two spirals depicted in FIGS. 2 and 3 are arranged in the substrate 2 above each other, preferably in a flush arrangement. They are interconnected to each other by a via between contacts 16 and 18. The contacts 16 and 18 outside of the spirals may be used for further interconnections, for example, to the conductors or copper tracks 10 in FIG. 1.

Due to the fact that the winding layouts may, for example, be realized in copper layers by, for example, wet chemical etching, photolithographic processes and suitable etching processes, complex winding layouts may be obtained, for example, for transformers. Furthermore, as indicated in FIGS. 2 and 3, intermediate connections may be realized, for example, by means of vias. With this, stacked arrangements may be possible where only one component with a complex winding is used, instead of two or more simple inductors which advantageously may reduce a component count in a size of the circuits.

Furthermore, instead of providing only one winding per inductive layer, it is also possible to realize more than one winding in one layer. Also, it possible to realize more than one winding in two layers. In case two windings should be accommodated in two layers, the windings are preferably interleaved. Such arrangements may be realized for example in (two layer) flex foils by interleaving the windings in the same layers. Also, one winding extending in two layers may be realized.

FIGS. 4 to 6 show an exemplary embodiment of such interleaving windings as they may be used in the inductor depicted in FIG. 1.

FIG. 4 shows a top view of a winding layout as it may be used in an interleaving winding arrangement, as depicted in FIG. 6. FIG. 5 shows a top view of the bottom layer layout as it may be used in the interleaving winding layout depicted in FIG. 6. FIG. 6 shows a perspective view of the winding layouts of FIGS. 4 and 5 with interconnections.

As may be taken from FIGS. 4 and 5, the winding layouts each have contacts 20 for contacting the windings to the outside and contacts 22 provided at an inside.

As may be taken from 6, by combining, i.e., interconnecting these two winding layouts depicted in FIGS. 4 and 5, two interleaving windings may be realized with different number of turns. The windings are connected to each other by means of interconnections 24 respectively connecting the contacts 22 of both windings to each other. Preferably, such a winding arrangement may be used for a transformer with interleaving windings. Although by suitably providing these interconnections 24 between windings in different layers, any combination of turn numbers may be achieved which allows for a great flexibility with respect to the inductor value or if the windings are used for a transformer for a high flexibility with respect to the transformer ratio.

Instead of a two layer arrangement, a multilayer arrangement may be realized. In such an arrangement the layers may be interconnected in series to obtain one winding with a high inductivity. It is also possible to interconnect some of the layers in parallel to achieve a lower resistance of the inductor. Of course, also a combination of parallel and series connection may be advantageous. Furthermore, some of the layers may be related to a first winding and other layers can be related to a second winding or further windings. This way, the windings need not to be interleaved, but are stacked on each other. However, also a multiple winding device is possible, which consists of a combination of interleaved windings and stacked windings. For example, this could be advantageous for a transformer with multiple outputs on the secondary side. The secondary windings are realized as interleaved windings (or tapped windings) in a first and second layer, which are stacked on the primary winding, realized by a third and forth layer.

Furthermore, one or more of the layers may be used for interconnections of the windings to each other or to external components. As an example, a layout with three layers is considered. The first layer is used for a first spiral winding, the second layer for a second spiral winding and the third layer is used to connect the centre points of each winding individually to the outside of the transformer.

These inductive components may advantageously be used in power electronic circuits like e.g. boost converters (up converters), buck converters (down converters), buck-boost converters, flyback converters, halfbridge converters, resonant converters. These power electronic circuits may have a single output or multiple outputs. They may be used for various applications, preferably with low power applications (from a few mW to approximately 5 W), e.g. for adapting battery voltage to the electronic circuitry in handheld devices, such as control circuits, displays and display backlighting. Further applications may be integrated battery charging circuits or drivers for light emitting diodes (LED).

1. Printed circuit board with an inductor, comprising:
a substrate, wherein the substrate has a first side and a second side;
an inductor core; and
a first winding;
wherein the first winding is provided in the substrate;
wherein the inductor core comprises a first softmagnetic layer and a second softmagnetic layer;
wherein the first softmagnetic layer is provided on the first side of the substrate and the second softmagnetic layer is provided on the second side of the substrate.

2. The printed circuit board of claim 1,
wherein the substrate comprises an electrically conductive layer;
wherein a wiring is provided; and
wherein the first winding and the wiring are provided in the electrically conductive layer.

3. The printed circuit board of claim 2,
wherein a shorted turn is defined in the electrically conductive layer, which shorted turn surrounds the winding and acts as a portion of a magnetic shield, which shield further includes an electrically conductive layer on top of the first softmagnetic layer.

4. The printed circuit board of claim 1,
wherein the first and second softmagnetic layers are plates of sintered ferrite.

5. The printed circuit board of claim 4,
wherein the substrate is a flex foil; and
wherein the plates of sintered ferrite are glued to the flex foil.

6. The printed circuit board of claim 1,
wherein the substrate is provided with a through-hole, in which through-hole an electrical connection to an inner end of the first winding is provided and in which through-hole a magnetic bridge between the first and the second softmagnetic layer is provided.

7. The printed circuit board of claim 6, wherein the magnetic bridge comprises a polymer material filled with magnetic particles, which filled polymer material extends at the first and the second side of the substrate as an adhesive between the first and the second softmagnetic layers and the substrate.

8. The printed circuit board of claim 1,
wherein the substrate includes a first layer and a second layer;
wherein the first winding comprises a second winding and a third winding
wherein the second winding is provided on the first layer and the third winding is provided on the second layer such that the second and third windings are provided in the substrate.

9. The printed circuit board of claim 1,
wherein a distance between the first softmagnetic layer and the second softmagnetic layer is selected such that it can be considered as an air gap in a magnetic path of a magnetic flux occurring between the first and second softmagnetic layers during operation of the inductor.

10. Inductor, comprising:
a substrate, wherein the substrate has a first side and a second side;
an inductor core; and
a first winding;
wherein the first winding is provided in the substrate;
wherein the inductor core comprises a first softmagnetic layer and a second softmagnetic layer;
wherein the first softmagnetic layer is provided on the first side of the substrate and the second softmagnetic layer is provided on the second side of the substrate.

11. A method of manufacturing an inductor, the method comprising the steps of:
providing a substrate, wherein the substrate has a first side and a second side;
providing a winding in the substrate; and
providing a first softmagnetic layer on the first side of the substrate and a second softmagnetic layer on the second side of the substrate;
wherein the first and second softmagnetic layers form an inductor core of the inductor.

12. The method of claim 11, further comprising the step of:
providing a wiring such that the wiring and the winding are provided in one conductive layer of the substrate.

13. The method of claim 11,
wherein the first and second softmagnetic layers are plates of sintered ferrite.

14. The method of claim 11,
wherein the substrate is one of a printed circuit board and flex foil; and
wherein the plates of sintered ferrite are glued to the printed circuit board.
